(19) United States
(12) Patent Application Publication
(10) Pub. No.: US 2026/0245989 A1
(43) Pub. Date: Aug. 20, 2026

(54) ROBUST BATTERY MANAGEMENT SYSTEM COMMUNICATIONS

(71) Applicant: STMicroelectronics International N.V., Geneva (CH)

(72) Inventors: Claudio Serratoni, Milano (IT); Valerio Bendotti, Vilminore di Scalve (IT)

(21) Appl. No.: 19/055,662

(22) Filed: Feb. 18, 2025

(51) Int. Cl. H01M 10/42; H01M 10/48; H01M 50/579

(52) U.S. Cl. CPC H01M 10/425; H01M 10/482; H01M 50/579; H01M 2010/4271; H01M 2010/4278

(57) ABSTRACT

According to an embodiment, a battery management system includes battery cells, a front-end circuit, a BMS ECU, and a communication interface circuit. The communication interface circuit includes half-bridge drivers coupled to internal isolation nodes, external isolation nodes, resistive networks between the internal and external nodes, a voltage comparator circuit, a clamping circuit, and an ESD protection circuit. The clamping circuit limits voltage excursions at the internal nodes, while the resistive networks develop detectable differential voltages during electromagnetic compatibility testing. The ESD protection circuit maintains trigger voltages above the sum of clamping voltage and resistive network voltage drops.

### TECHNICAL FIELD

The present disclosure generally relates to electronic systems and, in particular embodiments, to voltage clamping in battery management system communications.

### BACKGROUND

Electric vehicles rely on complex battery systems comprising multiple cells arranged in series and parallel configurations to achieve desired voltage and capacity levels. Each cell operates within specific voltage and temperature ranges to maintain safety, longevity, and optimal performance. Monitoring these parameters across all cells becomes increasingly advantageous as battery packs grow larger and more sophisticated.

Battery management systems incorporate front-end circuits distributed throughout the vehicle to capture real-time measurements from cell groups. These circuits monitor parameters like cell voltages, temperatures, state of charge, and potential cell degradation. The data collected from various points in the battery pack influences charging strategies, cell balancing decisions, and overall pack health assessment.

Automotive environments present electromagnetic compatibility challenges. Radio frequency interference can couple into communication lines from various sources like electric motors, power converters, and wireless systems. Industry standards define rigorous electromagnetic compatibility requirements through tests like Direct Power Injection (DPI) and Bulk Current Injection (BCI). These tests systematically inject noise currents at increasing power levels across a range of frequencies while verifying communication integrity.

### SUMMARY

Technical advantages are generally achieved by embodiments of this disclosure, which describe voltage clamping in battery management system communications.

A first aspect relates to a battery management system, comprising a plurality of battery cells; a front-end circuit coupled to the battery cells; a BMS electronic control unit (ECU); and a communication interface circuit coupled between the front-end circuit and the BMS ECU, the communication interface circuit comprising a first half-bridge driver circuit and a second half-bridge driver circuit, a first internal isolation node coupled to the first half-bridge driver circuit, a second internal isolation node coupled to the second half-bridge driver circuit, a first external isolation node and a second external isolation node, a first resistive network coupled between the first internal isolation node and the first external isolation node, a second resistive network coupled between the second internal isolation node and the second external isolation node, a voltage comparator circuit coupled to the first external isolation node and the second external isolation node, a clamping circuit coupled to the first internal isolation node and the second internal isolation node, the clamping circuit configured to limit voltage excursions at the first internal isolation node and the second internal isolation node, and an electrostatic discharge (ESD) protection circuit coupled between the first external isolation node and the second external isolation node, the ESD protection circuit configured with trigger voltages exceeding a sum of a clamping voltage and voltage drops across the first resistive network and the second resistive network.

A second aspect relates to a communication interface circuit, comprising a first half-bridge driver circuit and a second half-bridge driver circuit, a first internal isolation node coupled to the first half-bridge driver circuit, a second internal isolation node coupled to the second half-bridge driver circuit, a first external isolation node and a second external isolation node, a first resistive network coupled between the first internal isolation node and the first external isolation node, a second resistive network coupled between the second internal isolation node and the second external isolation node, a voltage comparator circuit coupled to the first external isolation node and the second external isolation node, a clamping circuit coupled to the first internal isolation node and the second internal isolation node, the clamping circuit configured to limit voltage excursions at the first internal isolation node and the second internal isolation node, and an electrostatic discharge (ESD) protection circuit coupled between the first external isolation node and the second external isolation node, the ESD protection circuit configured with trigger voltages exceeding a sum of a clamping voltage and voltage drops across the first resistive network and the second resistive network.

A third aspect relates to a method of operating a communication interface circuit during electromagnetic compatibility testing, the method comprising implementing voltage clamping at a first internal isolation node and a second internal isolation node; generating differential signals using a first half-bridge driver circuit coupled to the first internal isolation node and a second half-bridge driver circuit coupled to the second internal isolation node; developing voltage drops across a first resistive network coupled between the first internal isolation node and a first external isolation node and a second resistive network coupled between the second internal isolation node and a second external isolation node; and detecting differential voltages between the first external isolation node and the second external isolation node using a voltage comparator circuit while maintaining electrostatic discharge protection trigger voltages above a sum of a clamping voltage and the voltage drops.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a block diagram of an embodiment battery management system, which may be incorporated within an electric vehicle;

FIG. 2 is a block diagram of an embodiment vertical interface;

FIG. 3 is a schematic diagram of an embodiment communication interface circuit;

FIG. 4 is a schematic diagram of an embodiment communication interface circuit;

FIG. 5 is a schematic diagram of an embodiment communication interface circuit;

FIG. 6 is a schematic diagram of an embodiment communication interface circuit;

FIG. 7 is a schematic diagram of an embodiment communication interface circuit; and

FIG. 8 is a flowchart of an embodiment method for operating a communication interface circuit during electromagnetic compatibility testing, such as Direct Power Injection (DPI) and Bulk Current Injection (BCI) testing.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

While the inventive aspects are described primarily in the context of battery management systems for electric vehicles, it should also be appreciated that these inventive aspects may also apply to any system requiring isolated differential communications in noisy environments. In particular, aspects of this disclosure may similarly apply to high-voltage and low-voltage battery management systems for electric bicycles, electric scooters, electric motorcycles, energy storage systems, uninterruptible power supplies, grid storage applications, industrial control systems, power distribution monitoring, medical equipment, renewable energy systems, data center power management, marine applications, robotics, drones, portable electronics, and other applications where robust isolated data transmission between circuits operating at different ground potentials is desirable.

Embodiments of the disclosure relate to differential communication interfaces that maintain signal integrity during electromagnetic compatibility testing. A galvanically isolated interface includes voltage clamping structures and strategically placed resistive elements that allow differential signal detection even when large common-mode noise currents are present. The interface architecture preserves low voltage requirements for driver circuits while enhancing immunity to electromagnetic disturbances.

In embodiments, the communication interface uses half-bridge drivers to generate differential signals representing digital data across isolated transmission lines. Internal nodes incorporate voltage clamping through power supply rails or dedicated clamping circuits that limit voltage excursions. Series resistors between the clamped internal nodes and external interface pins develop measurable differential voltages from communication signals and noise currents. Comparator circuits coupled to the external pins can detect these differential voltages to recover transmitted data.

Multiple voltage clamping approaches can be implemented based on system requirements. Power supply rail clamping through Metal-Oxide-Semiconductor Field-Effect Transistor (MOSFET) body diodes provides inherent voltage limiting. When power supply current-sinking capability is limited, dedicated clamping structures can be added. The clamping techniques can be combined and supplemented with additional resistive elements for impedance matching and common-mode noise filtering.

In embodiments, the interface supports 4 megahertz (MHz) differential signaling between battery management circuits with different ground potentials. Decoupling capacitors maintain galvanic isolation while allowing signal propagation. Logic “1” manifests as a positive voltage on one line coupled with a simultaneous negative voltage on the complementary line, followed by the inverse pattern. Logic “0” uses the opposite sequence. The voltage clamping and resistive elements preserve this signaling scheme during electromagnetic compatibility testing, such as Direct Power Injection (DPI) and Bulk Current Injection (BCI).

The architecture enables robust communication in electrically noisy automotive environments without requiring high-voltage components or complex filtering. The placement of clamps and resistors maintains signal detection capability even when Electrostatic Discharge (ESD) protection circuits activate due to large common-mode disturbances. The interface integrates seamlessly with existing battery management system implementations, providing enhanced noise immunity.

Embodiments of the disclosure provide several advantages over existing solutions. By implementing voltage clamping and resistive networks rather than increasing component voltage ratings, the communication interface achieves reduced silicon area and lower manufacturing costs. Maintaining low-voltage class components enables higher communication speeds while reducing average current consumption. This approach eliminates the need for specialized high-voltage process technologies or additional isolation structures that would otherwise increase complexity and cost.

The proposed voltage clamping techniques allow the half-bridge drivers and associated circuitry to operate with standard voltage ratings while maintaining robust performance during electromagnetic compatibility testing. The placement of series resistors and clamping structures provides the necessary protection against common-mode disturbances without requiring higher voltage components throughout the interface, resulting in a more efficient and cost-effective implementation. These and additional details are discussed below.

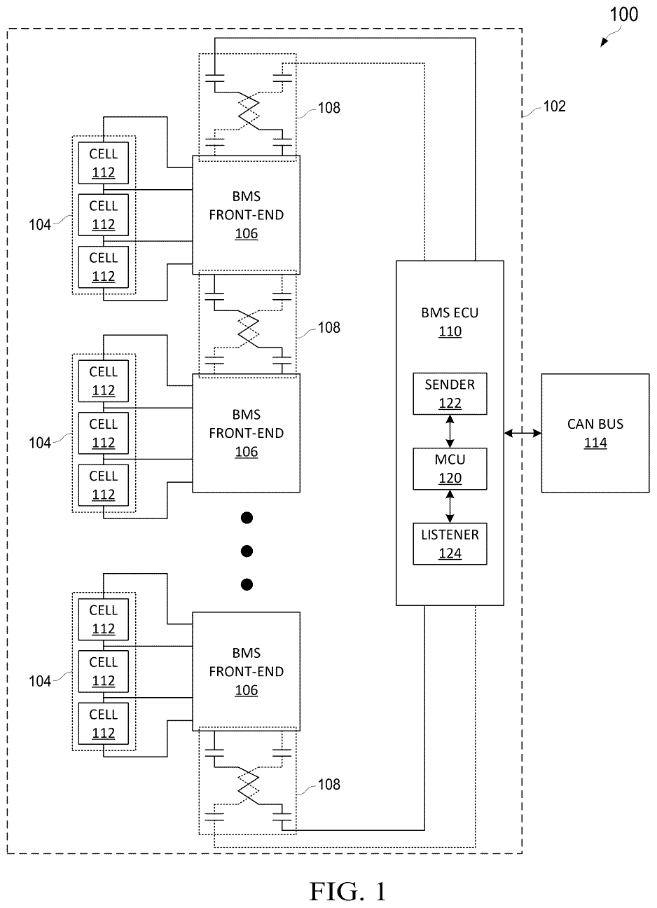

FIG. 1 illustrates a block diagram of an embodiment battery management system 100, which may be incorporated within an electric vehicle. Battery management system 100 includes a battery pack 102 coupled to a Controller Area Network (CAN) bus 114. The battery pack 102 includes multiple cell groups 104—each including multiple individual cells 112, multiple Battery Management System (BMS) front-end circuits 106, and a BMS Electronic Control Unit (ECU) 110, which may (or may not) be arranged as shown.

The BMS ECU 110 can include a microcontroller (MCU) 120 for processing, and a sender circuit 122 and a listener circuit 124 for managing communication with the BMS front-end circuits 106 through the vertical interfaces 108. The microcontroller 120 can communicate with the sender circuit 122 and the listener circuit 124 through Serial Peripheral Interface (SPI) and Battery Network Enable (BNE) interfaces.

While three individual cells 112 are shown in each cell group 104 and three BMS front-end circuits 106 are illustrated, this configuration is non-limiting and fewer or greater numbers of cells and front-end circuits are contemplated in various embodiments. Further, battery management system 100 may include additional components not shown.

Each BMS front-end circuit 106 captures information from its associated cell group 104, such as cell voltages, temperatures, or other parameters. The captured information is communicated through vertical interfaces 108 to the BMS ECU 110, which analyzes the data and controls charging operations for the individual cells 112. The vertical interfaces 108 can include differential communication pair wires that maintain isolation between different sections of the battery pack 102. Each vertical interface 108 can include isolation components such as decoupling capacitors and resistors to maintain proper signal transmission while preserving galvanic isolation between sections.

The BMS front-end circuits 106 are arranged in a daisy-chain configuration through the vertical interfaces 108, enabling efficient communication of cell information up to the BMS ECU 110. The individual cells 112 within cell groups 104 can be positioned at different physical locations throughout the electric vehicle, with varying distances between them. This distributed architecture can make the vertical interfaces 108 susceptible to Electromagnetic Interference (EMI) from various vehicle systems. Therefore, it is advantageous for the communication interface to have robust performance during Direct Power Injection (DPI) and Bulk Current Injection (BCI) testing to ensure reliable operation in noisy automotive environments.

The BMS ECU 110 interfaces with vehicle systems through the CAN bus 114, providing battery status information and receiving control commands. The modular architecture allows scalable battery pack configurations while maintaining reliable communication between distributed monitoring circuits through the vertical interfaces 108.

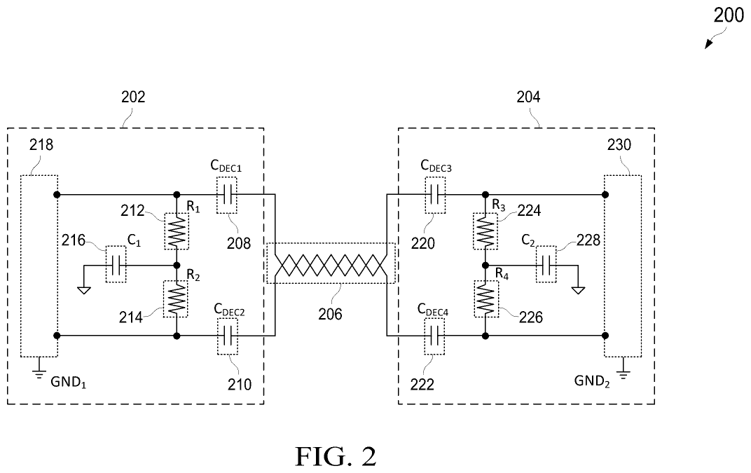

FIG. 2 illustrates a block diagram of an embodiment vertical interface 200, which may be implemented as the vertical interface 108 of FIG. 1. Vertical interface 200 includes a first board 202 coupled to a second board 204 via a differential pair 206 of wires. The differential pair 206 can be implemented as a twisted pair. In embodiments, the impedance of the differential pair 206 is 120 ohms to support communication frequencies of approximately 4 megahertz (MHz).

The first board 202 includes a first decoupling capacitor (C_{DEC1}) 208, a second decoupling capacitor (C_{DEC2}) 210, a first resistor (R₁) 212, a second resistor (R₂) 214, and a first capacitor (C₁) 216, which may (or may not be arranged as shown). The first board 202 is couplable to a first device 218, with a first ground connection (GND₁). The first resistor (R₁) 212 and the second resistor (R₂) 214, along with the first capacitor (C₁) 216, can provide impedance matching and common-mode noise filtering.

The second board 204 includes a third decoupling capacitor (C_{DEC3}) 220, a fourth decoupling capacitor (C_{DEC4}) 222, a third resistor (R₃) 224, a fourth resistor (R₄) 226, and a second capacitor (C₂) 228, which may (or may not be arranged as shown). The second board 204 is couplable to a second device 230, with a second ground connection (GND₂). Similar to the first board, the third resistor (R₃) 224 and the fourth resistor (R₄) 226, along with the second capacitor (C₂) 228, can provide impedance matching and common-mode noise filtering.

The decoupling capacitors maintain galvanic isolation between the boards while allowing differential signal transmission. The impedance-matching components on both boards are selected to match the characteristic impedance of the differential pair 206, minimizing signal reflections. In some embodiments, a transformer may be used instead of decoupling capacitors to provide isolation between the boards with different ground potentials.

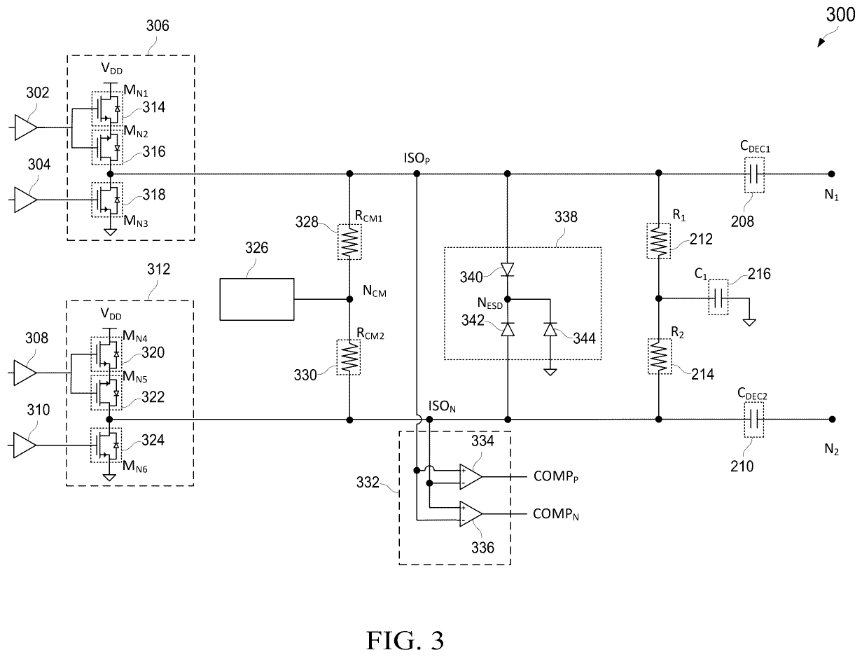

FIG. 3 illustrates a schematic diagram of an embodiment communication interface circuit 300. The communication interface circuit 300 illustrates a detailed implementation of one side of the vertical interface 200 shown in FIG. 2, specifically the circuitry that may be implemented in first board 202.

The communication interface circuit 300 includes a first driver 302, a second driver 304, a first half-bridge driver circuit 306, a third driver 308, a fourth driver 310, a second half-bridge driver circuit 312, a common-mode voltage biasing circuit 326, a first common-mode resistor (R_{CM1}) 328, a second common-mode resistor (R_{CM2}) 330, a voltage comparator circuit 332, an Electrostatic Discharge (ESD) protection circuit 338, the first resistor (R₁) 212, the second resistor (R₂) 214, the first capacitor (C₁) 216, the first decoupling capacitor (C_{DEC1}) 208, and the second decoupling capacitor (C_{DEC2}) 210, which may (or may not) be arranged as shown. The communication interface circuit 300 may include additional components not shown. For components previously described, their structure and function are not repeated here for brevity.

In embodiments, the positive isolation node (ISO_{P}) and negative isolation node (ISO_{N}) are implemented as external pins of the communication interface circuit 300, allowing connection to external components such as the decoupling capacitors and twisted pair communication lines.

The first half-bridge driver circuit 306 includes a first complementary Metal-Oxide-Semiconductor Field-Effect Transistors (MOSFET) arrangement comprising a first n-channel transistor (M_{N1}) 314 and a second n-channel transistor (M_{N2}) 316 in addition to a third n-channel transistor (M_{N3}) 318. The gate terminals of the first n-channel transistor (M_{N1}) 314 and the second n-channel transistor (M_{N2}) 316 are driven by the first driver 302 and the gate terminal of the third n-channel transistor (M_{N3}) 318 is driven by the second driver 304. The drain terminal of the first n-channel transistor (M_{N1}) 314 is coupled to a supply voltage (V_{DD}), the source terminal of the second n-channel transistor (M_{N2}) 316 is coupled to the source terminal of the first n-channel transistor (M_{N1}) 314, the drain terminal of the second n-channel transistor (M_{N2}) 316 is coupled to the drain terminal of the third n-channel transistor (M_{N3}) 318 at the positive isolation node (ISO_{P}), and the source terminal of the third n-channel transistor (M_{N3}) 318 is coupled to ground.

Likewise, the second half-bridge driver circuit 312 includes a second complementary MOSFET arrangement comprising a fourth n-channel transistor (M_{N4}) 320, a fifth n-channel transistor (M_{N5}) 322, and a sixth n-channel transistor (M_{N6}) 324. The gate terminals of the fourth n-channel transistor (M_{N4}) 320 and the fifth n-channel transistor (M_{N5}) 322 are driven by the third driver 308, and the gate terminal of the sixth n-channel transistor (M_{N6}) 324 is driven by the fourth driver 310. The drain terminal of the fourth n-channel transistor (M_{N4}) 320 is coupled to the supply voltage (V_{DD}), the source terminal of the fifth n-channel transistor (M_{N5}) 322 is coupled to the source terminal of the fourth n-channel transistor (M_{N4}) 320, the drain terminal of the fifth n-channel transistor (M_{N5}) 322 is coupled to the drain terminal of the sixth n-channel transistor (M_{N6}) 324 at the negative isolation node (ISO_{N}), and the source terminal of the sixth n-channel transistor (M_{N6}) 324 is coupled to ground.

A common-mode voltage biasing circuit (VMC) 326 biases the average voltage between the positive isolation node (ISO_{P}) and negative isolation node (ISO_{N}) through a first common-mode resistor (R_{CM1}) 328 and the second common-mode resistor (R_{CM2}) 330. The first common-mode resistor (RCM1) 328 is coupled between the positive isolation node (ISO_{P}) and the common-mode node (N_{CM}), while the second common-mode resistor (R_{CM2}) 330 is coupled between the common-mode node (N_{CM}) and the negative isolation node (ISO_{N}). The voltage at the common-mode node (N_{CM}) represents the common-mode voltage level of the differential interface.

The ESD protection circuit 338 includes a first diode 340, a second diode 342, and a third diode 344. The first diode 340 and the second diode 342 are arranged in a back-to-back configuration, with their cathodes coupled to each other at a common ESD node (N_{ESD}). The anode of the first diode 340 is coupled to the positive isolation node (ISO_{P}), and the anode of the second diode 342 is coupled to the negative isolation node (ISO_{N}). The cathode of the third diode 344 is coupled to the common ESD node (N_{ESD}), and the anode of the third diode 344 is coupled to ground. The ESD protection circuit 338 provides bidirectional protection while preventing power supply current injection.

Voltage comparator circuit 332 includes a first comparator 334 and a second comparator 336. The non-inverting input of the first comparator 334 is coupled to the positive isolation node (ISO_{P}), and the inverting input of the first comparator 334 is coupled to the negative isolation node (ISO_{N}). The inverting input of the second comparator 336 is coupled to the positive isolation node (ISO_{P}), and the non-inverting input of the second comparator 336 is coupled to the negative isolation node (ISO_{N}). The first comparator 334 generates a positive comparator signal (COMP_{P}), and the second comparator 336 generates a negative comparator signal (COMP_{N}) based on the differential voltages present at these nodes. In embodiments, each comparator includes positive trigger thresholds to ensure their outputs remain low when no differential signal is present.

Communication occurs by controlling the first half-bridge driver circuit 306 and the second half-bridge driver circuit 312 to generate differential signals. To transmit a logic ‘1’, the first half-bridge driver circuit 306 raises the voltage on the positive isolation node (ISO_{P}) by turning ON the first complementary MOSFET arrangement and turning OFF the third n-channel transistor (M_{N3}) 318, while the second half-bridge driver circuit 312 simultaneously lowers the voltage on the negative isolation node (ISO_{N}) by turning OFF the second complementary MOSFET arrangement and turning ON the sixth n-channel transistor (M_{N6}) 324.

This initial pattern is followed by the inverse sequence where the first half-bridge driver circuit 306 lowers the positive isolation node (ISO_{P}) by turning ON the third n-channel transistor (M_{N3}) 318 and turning OFF the first complementary MOSFET, while the second half-bridge driver circuit 312 raises the negative isolation node (ISO_{N}) by turning ON the second complementary MOSFET arrangement and turning OFF the sixth n-channel transistor (M_{N6}) 324. A logic ‘0’ is transmitted using the opposite sequence of these patterns.

The differential voltage created between the positive isolation node (ISO_{P}) and the negative isolation node (ISO_{N}) in the first board 202 is detected in the second board 204 by the voltage comparator circuit 332. The first comparator 334 generates the positive comparator signal (COMP_{P}) and the second comparator 336 generates the negative comparator signal (COMP_{N}). These comparator signals process the communicated data by detecting the differential voltage patterns that represent logic ‘1’ and logic ‘0’ states.

During periods between data transmission, the first half-bridge driver circuit 306 and the second half-bridge driver circuit 312 can maintain an idle state where the positive isolation node (ISO_{P}) and the negative isolation node (ISO_{N}) are held at the same voltage potential.

During Direct Power Injection (DPI) or Bulk Current Injection (BCI) testing, large noise currents can be injected into the differential inputs (i.e., at nodes N₁ and N₂) of the communication interface circuit 300. When multiplied by the input impedance of the differential interface, these injected currents develop voltages at the positive isolation node (ISO_{P}) and the negative isolation node (ISO_{N}).

The developed voltages can reach levels capable of triggering the ESD protection circuit 338. When the ESD protection circuit 338 activates, it causes signal rectification that can mask the communication signals. The back-to-back configuration of the first diode 340 and the second diode 342 prevents current injection into the supply voltage (V_{DD}). Still, when triggered, the ESD protection can interfere with normal signal detection.

When signal rectification occurs due to ESD protection activation, the differential voltage between the positive isolation node (ISO_{P}) and the negative isolation node (ISO_{N}) becomes corrupted. As a result, the first comparator 334 and the second comparator 336 cannot properly switch to detect the transmitted data patterns, leading to communication failure.

One approach to maintaining communication functionality during radio frequency noise conditions involves increasing the voltage threshold at which the ESD protection structures activate. By raising these threshold voltages, the ESD protection circuit remains inactive during noise events, allowing the differential voltages that develop at the input pins to remain detectable by the comparator circuits.

However, this solution introduces several drawbacks. Increasing the ESD protection threshold voltages necessitates raising the voltage class of all components in the communication interface circuit. This higher voltage component requirement impacts the overall device area and achievable communication speeds. The increased voltage ratings affect numerous circuit elements, including the driver transistors, comparators, and associated components.

Further, the voltage class increase affects both positive and negative voltage handling capabilities, as the communication signals may need to swing below ground potential by 10-20 volts. Implementing these expanded voltage ranges can be particularly challenging in semiconductor technologies lacking isolated substrate components. The need for specialized process technologies or additional isolation structures substantially increases manufacturing complexity and cost.

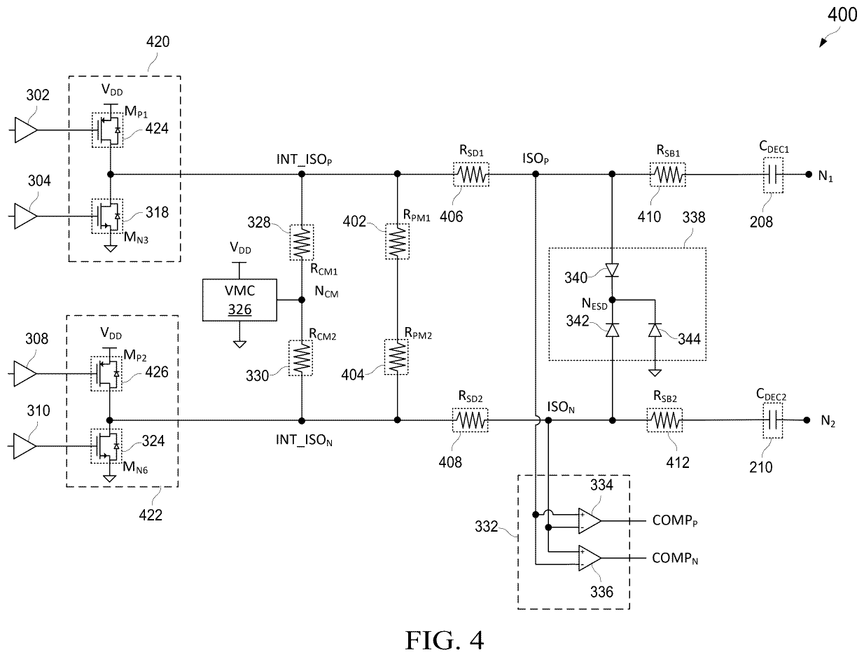

FIG. 4 illustrates a schematic diagram of an embodiment communication interface circuit 400. The communication interface circuit 400 illustrates a detailed implementation of one side of the vertical interface 200 shown in FIG. 2, specifically the circuitry that may be implemented in first board 202.

The communication interface circuit 400 includes a first pull-mode resistor (R_{PM1}) 402, a first series differential resistor (R_{SD1}) 406, and a first series board resistor (R_{SB1}) 410, which replaces the first resistor (R₁) 212. Further, a second pull-mode resistor (R_{PM2}) 404, a second series differential resistor (R_{SD2}) 408, and a second series board resistor (R_{SB2}) 412 replace the second resistor (R₂) 214.

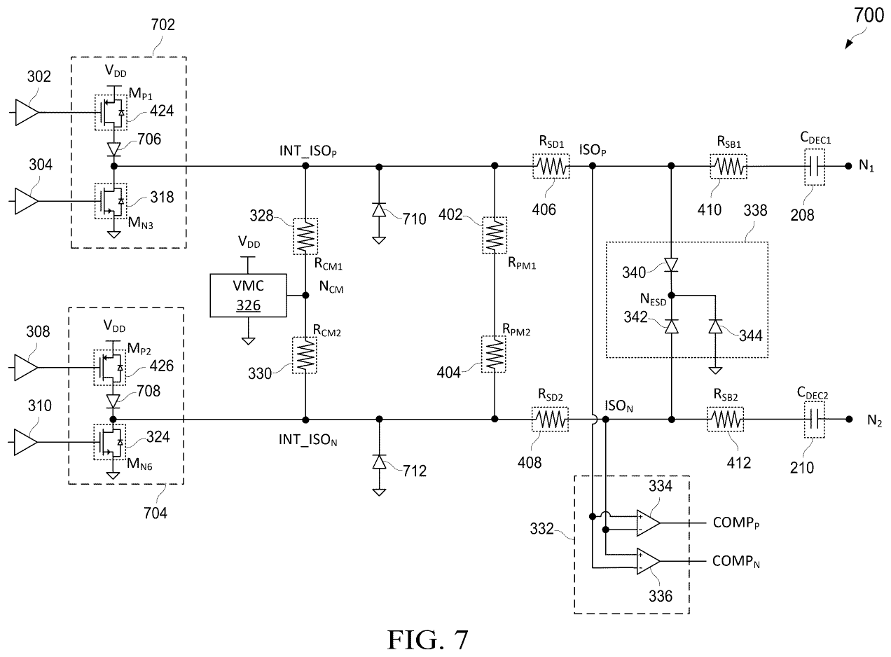

Further, the first half-bridge driver circuit 306 is replaced with the first half-bridge driver circuit 420, where the first n-channel transistor (M_{N1}) 314 and the second n-channel transistor (M_{N2}) 316 are replaced with a first p-channel transistor (M_{P1}) 424. This is because the power supply line isolation through the back-to-back structure becomes unnecessary when implementing the p-channel transistor. As shown in FIG. 7, in embodiments where the power supply creates a voltage clamp and the supply voltage (V_{DD}) lacks sufficient robustness, diodes, such as those shown in FIG. 7, can be added. Advantageously, the p-channel implementation provides area savings on the circuit by eliminating multiple n-channel transistors. Further, a charge pump or higher supply voltage greater than the supply voltage (V_{DD}) is no longer required to activate the transistors without attenuating the supply voltage (V_{DD}), given the series differential, pull-mode, and first series board resistors.

The first driver 302 is coupled to the gate terminal of the first p-channel transistor (M_{P1}) 424. The second half-bridge driver circuit 312 is replaced with the first half-bridge driver circuit 422, where the fourth n-channel transistor (M_{N4}) 320 and the fifth n-channel transistor (M_{N5}) 322 are replaced with a second p-channel transistor (M_{P2}) 426. The third driver 308 is coupled to the gate terminal of the second p-channel transistor (M_{P2}) 426. The components previously discussed concerning FIG. 3 are not repeated for the brevity of the discussion. The communication interface circuit 400 may include additional components not shown.

Given the additional series resistors between the positive isolation node (ISO_{P}) and negative isolation node (ISO_{N}), the communication interface circuit 400 includes an internal positive isolation node (INT_ISO_{P}) and an internal negative isolation node (INT_ISO_{N}). The total series resistance between each internal node and its corresponding external node comprises the sum of its respective pull-mode resistor, series differential resistor, and series board resistor. While the distribution of resistance values among these three resistors can be flexible, the first series differential resistor (R_{SD1}) 406 and the second series differential resistor (R_{SD2}) 408 are maintained at non-zero values.

The internal positive isolation node (INT_ISO_{P}) is at the common node between the first half-bridge driver circuit 420, the first common-mode resistor (R_{CM1}) 328, the first pull-mode resistor (R_{PM1}) 402, and the first series differential resistor (R_{SD1}) 406. The positive isolation node (ISO_{P}) is the common node between the first series differential resistor (R_{SD1}) 406, the voltage comparator circuit 332, the ESD protection circuit 338, and the first series board resistor (R_{SB1}) 410.

The internal negative isolation node (INT_ISO_{N}) is at the common node between the second half-bridge driver circuit 422, the second common-mode resistor (R_{CM2}) 330, the second pull-mode resistor (R_{PM2}) 404, and the second series differential resistor (R_{SD2}) 408. The positive isolation node (ISO_{P}) is the common node between the second series differential resistor (R_{SD2}) 408, the voltage comparator circuit 332, the ESD protection circuit 338, and the second series board resistor (R_{SB2}) 412.

The internal positive isolation node (INT_ISO_{P}) and the internal negative isolation node (INT_ISO_{N}) are self-clamped through the body diodes of the MOSFETs in the half-bridge driver circuits when the supply voltage (V_{DD}) sources or sinks current. During Direct Power Injection or Bulk Current Injection testing, these internal nodes may experience signal rectification, while the positive isolation node (ISO_{P}) and the negative isolation node (ISO_{N}) maintain uncorrupted differential signals across the first series differential resistor (R_{SD1}) 406 and the second series differential resistor (R_{SD2}) 408.

The first series differential resistor (R_{SD1}) 406 and the second series differential resistor (R_{SD2}) 408 develop voltages comprising the common-mode noise and differential signal components. The ESD protection circuit 338 and voltage comparator circuit 332 are configured to maintain proper operation with these combined voltage components, enabling reliable data recovery even during electromagnetic compatibility testing.

By implementing this resistive network and utilizing the self-clamping characteristics of the internal nodes, the voltage class of the components in the first half-bridge driver circuit 420 and the second half-bridge driver circuit 422 do not need to be increased. The first series differential resistor (R_{SD1}) 406 and the second series differential resistor (R_{SD2}) 408 develop the necessary voltage drops to handle large common-mode disturbances while maintaining low voltage requirements for the internal circuitry. This approach provides electromagnetic compatibility without requiring higher voltage components, thereby maintaining a smaller device area and lower manufacturing costs.

The ESD protection circuit 338 is sized to not trigger even with the maximum expected disturbance current value combined with the maximum communication signal current value. This sizing ensures that the ESD protection remains inactive during normal operation and electromagnetic compatibility testing.

The voltage comparator circuit 332 is designed to appropriately detect differential voltages at the positive isolation node (ISO_{P}) and negative isolation node (ISO_{N}) that exceed fixed thresholds. The first comparator 334 and the second comparator 336 can properly switch states based on these threshold crossings, enabling correct decoding of the communication signals even in the presence of common-mode noise voltages developed across the first series differential resistor (R_{SD1}) 406 and the second series differential resistor (R_{SD2}) 408.

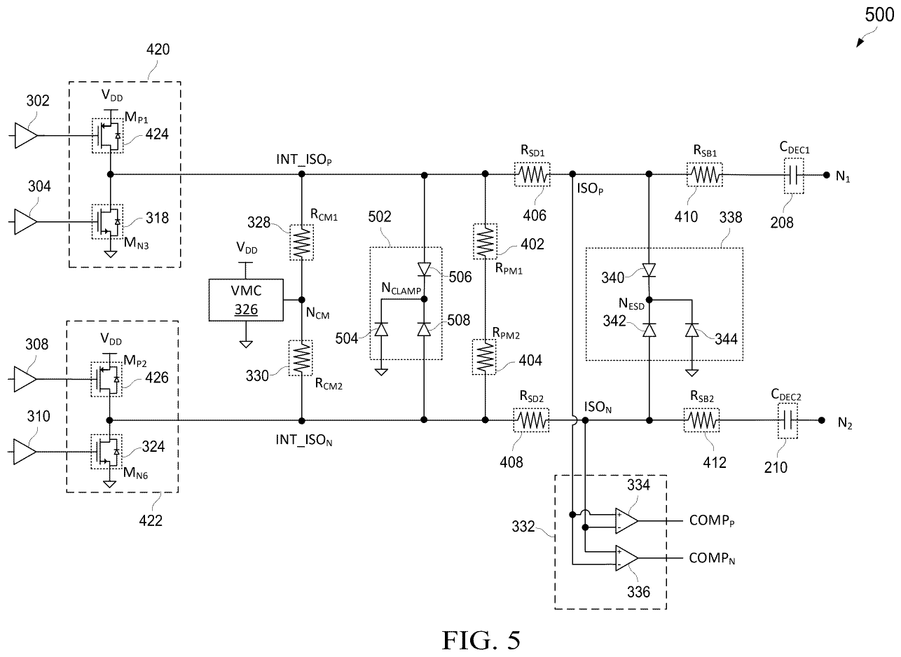

FIG. 5 illustrates a schematic diagram of an embodiment communication interface circuit 500. The communication interface circuit 500 illustrates a detailed implementation of one side of the vertical interface 200 shown in FIG. 2, specifically the circuitry that may be implemented in first board 202.

In addition to the components previously discussed in FIG. 4, the communication interface circuit 500 includes a clamping circuit 502, which includes a first clamping diode 504, a second clamping diode 506, and a third clamping diode 508, which may (or may not) be arranged as shown. The communication interface circuit 500 may include additional components not shown.

The second clamping diode 506 and the third clamping diode 508 are arranged in a back-to-back configuration, with their cathodes coupled to each other at a clamp node (N_{CLAMP}). The anode of the second clamping diode 506 is coupled to the internal positive isolation node (INT_ISO_{P}) and the anode of the third clamping diode 508 is coupled to the internal negative isolation node (INT_ISO_{N}). The cathode of the first clamping diode 504 is coupled to the clamp node (N_{CLAMP}) and the anode of the first clamping diode 504 is coupled to ground.

The clamping circuit 502 limits voltage excursions on the internal positive isolation node (INT_ISO_{P}) and internal negative isolation node (INT_ISO_{N}) during large common-mode disturbances, such as those present during Bulk Current Injection testing. When a significant common-mode component is present, the clamping circuit 502 ensures that the voltages at these internal nodes are equal: V_{INT_ISOP}=V_{INT_ISON}.

The current injected through the first decoupling capacitor (C_{DEC1}) 208 and the second decoupling capacitor (C_{DEC2}) 210 can be expressed as the sum of two components: a common-mode current component (I_{CM}) and a differential current component (I_{DIFF}).

A first voltage drop (ΔV_{RSD_P}) develops across the first series differential resistor (R_{SD1}) 406, while a second voltage drop (ΔV_{RSD_N}) develops across the second series differential resistor (R_{SD2}) 408. When the first series differential resistor (R_{SD1}) 406 and the second series differential resistor (R_{SD2}) 408 have equal resistance values (R), these voltage drops can be expressed as ΔV_{RSD_P}=R×(I_{CM}+I_{DIFF}) and ΔV_{RSD_N}=R×(I_{CM}-I_{DIFF}), where I_{CM} represents the common-mode current component and I_{DIFF} represents the differential current component.

The resulting differential voltage between the external positive isolation node (ISO_{P}) and negative isolation node (ISO_{N}) equals 2×R×I_{DIFF}, which can be detected by the voltage comparator circuit 332. Under normal conditions without common-mode noise, if we consider R_{PM1}+R_{PM2}=R, the differential voltage equals 3×R×I_{DIFF}. While common-mode noise attenuates the differential signal by one-third, the voltage comparator circuit 332 can still accurately detect the signal.

The clamping circuit 502 allows the first half-bridge driver circuit 420 and the second half-bridge driver circuit 422 to maintain low voltage class requirements without impacting the silicon area. The ESD protection circuit 338 is configured with trigger voltages that exceed the sum of the clamping voltage (V_{CLAMP}) at the clamp node (N_{CLAMP}) and the first voltage drop (ΔV_{RSD_P}) and the second voltage drop (ΔV_{RSD_N}) across the first series differential resistor (R_{SD1}) 406 and the second series differential resistor (R_{SD2}) 408, respectively (i.e., V_{CLAMP}+ΔV_{RSD_P}& V_{CLAMP}+ΔV_{RSD_N}<Trigger voltage of ESD protection circuit 338). This ensures the ESD protection circuit 338 does not activate during common-mode disturbances.

While most components in the communication interface can maintain standard voltage ratings, the voltage comparator circuit 332 may need a higher voltage class configuration. This can stem from the need to accurately detect differential signals in the presence of elevated common-mode voltages that develop across the series resistors during electromagnetic compatibility testing. The voltage comparator circuit 332 must maintain proper operation across an expanded common-mode input range while preserving its differential voltage detection sensitivity.

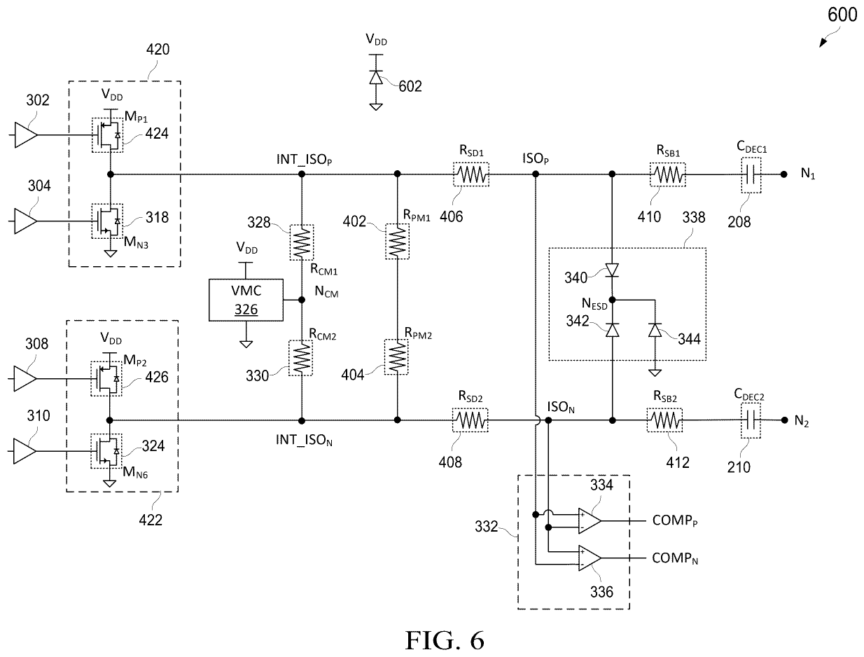

FIG. 6 illustrates a schematic diagram of an embodiment communication interface circuit 600. The communication interface circuit 600 illustrates a detailed implementation of one side of the vertical interface 200 shown in FIG. 2, specifically the circuitry that may be implemented in first board 202. The embodiment shown in FIG. 6 can be implemented with the embodiment shown in FIG. 5.

In addition to the components previously discussed in FIG. 4, the communication interface circuit 600 includes a clamping diode 602. The clamping diode 602 is coupled between the supply voltage (V_{DD}) and ground, with its cathode coupled to the supply voltage (V_{DD}) and its anode coupled to ground. The communication interface circuit 600 may include additional components not shown.

The supply voltage (V_{DD}) can typically provide the required current, including radio frequency noise current, but may not be able to absorb incoming current without experiencing a voltage increase. The clamping diode 602 activates when the supply voltage (V_{DD}) rises above a target value, thereby limiting the voltage on the internal positive isolation node (INT_ISO_{P}) and the internal negative isolation node (INT_ISO_{N}).

This voltage limiting on the internal nodes allows the communication signals to develop across the first series differential resistor (R_{SD1}) 406 and the second series differential resistor (R_{SD2}) 408. These differential voltages can be detected by the first comparator 334 and the second comparator 336 of the voltage comparator circuit 332. This implementation provides a solution for systems where the supply voltage (V_{DD}) can source current but not sink current.

FIG. 7 illustrates a schematic diagram of an embodiment communication interface circuit 700. The communication interface circuit 700 illustrates a detailed implementation of one side of the vertical interface 200 shown in FIG. 2, specifically the circuitry that may be implemented in first board 202. The embodiment shown in FIG. 7 can be implemented with the embodiment shown in FIG. 5, the embodiment shown in FIG. 6, or both.

In addition to the components previously discussed in FIG. 4, the communication interface circuit 700 includes a first clamping diode 706 in the first half-bridge driver circuit 702, a second clamping diode 708 in the second half-bridge driver circuit 704, a third clamping diode 710, and a fourth clamping diode 712, which may (or may not) be arranged as shown.

The first half-bridge driver circuit 702 is substantially the same as the first half-bridge driver circuit 420 with the addition of the first clamping diode 706. The anode of the first clamping diode 706 is coupled to the drain terminal of the first p-channel transistor (M_{P1}) 424. The cathode of the first clamping diode 706 is coupled to the drain terminal of the third n-channel transistor (M_{N3}) 318, the cathode of the third clamping diode 710, the first common-mode resistor (R_{CM1}) 328, the first pull-mode resistor (R_{PM1}) 402, and the first series differential resistor (R_{SD1}) 406 at the internal positive isolation node (INT_ISO_{P}).

The second half-bridge driver circuit 704 is substantially the same as the second half-bridge driver circuit 422 with the addition of the second clamping diode 708. The anode of the second clamping diode 708 is coupled to the drain terminal of the second p-channel transistor (M_{P2}) 426. The cathode of the second clamping diode 708 is coupled to the drain terminal of the sixth n-channel transistor (M_{N6}) 324, the cathode of the fourth clamping diode 712, the second common-mode resistor (R_{CM2}) 330, the second pull-mode resistor (R_{PM2}) 404, and the second series differential resistor (R_{SD2}) 408 at the internal negative isolation node (INT_ISO_{N}).

The anodes of the third clamping diode 710 and the fourth clamping diode 712 are coupled to ground. This dedicated clamping structure prevents current injection into the supply voltage (V_{DD}), which could affect other circuits within the same device. The clamping diodes limit the voltage on the internal positive isolation node (INT_ISO_{P}) and internal negative isolation node (INT_ISO_{N}), allowing communication signals to develop across the first series differential resistor (R_{SD1}) 406 and second series differential resistor (R_{SD2}) 408 for detection by the voltage comparator circuit 332.

Alternative implementations of the clamping structure are possible, including a unified clamp for both internal nodes that provides symmetrical current handling when activated. This embodiment provides a solution for systems where the supply voltage (V_{DD}) can source current but not sinking current, while maintaining voltage limitations on the internal nodes without affecting the communication signal detection capability.

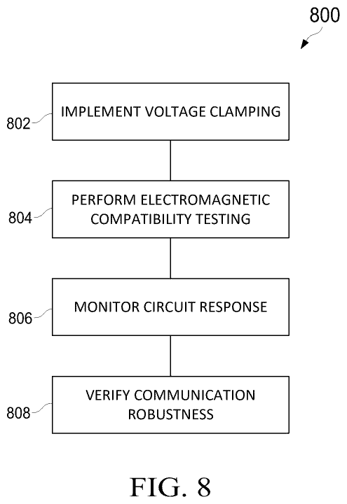

FIG. 8 illustrates a flowchart of an embodiment method 800 for operating a communication interface circuit during electromagnetic compatibility testing, such as Direct Power Injection (DPI) and Bulk Current Injection (BCI) testing. It is noted that all steps outlined in the method are not necessarily required and can be optional. Further, changes to the arrangement of the steps, removal of one or more steps and path connections, and addition of steps and path connections are similarly contemplated.

At step 802, the method includes implementing voltage clamping at the internal positive isolation node (INT_ISO_{P}) and internal negative isolation node (INT_ISO_{N}) to handle large common-mode disturbances. The voltage clamping can be achieved by utilizing MOSFET body diodes in the half-bridge drivers when the supply voltage (V_{DD}) can both source and sink current, implementing a clamping diode at the supply voltage (V_{DD}) to prevent voltage increase from incoming currents, adding dedicated clamping circuits with back-to-back diode arrangements at the internal nodes to prevent current injection into the supply voltage (V_{DD}), or combining these approaches based on system requirements.

At step 804, electromagnetic compatibility testing is performed according to, for example, standardized test procedures. During Direct Power Injection (DPI) testing, RF power is directly injected into the communication interface at various frequencies up to specified power levels. During Bulk Current Injection (BCI) testing, RF current is inductively coupled into the communication lines using current injection probes according to specified test profiles. The testing systematically increases injection levels while monitoring for communication failures.

At step 806, circuit response is monitored during testing. The injected currents, comprising common-mode and differential components, develop voltage drops across the series differential resistors. The clamping ensures equal voltages at the internal nodes during significant common-mode disturbances while allowing a detectable differential voltage to develop between the external isolation nodes.

At step 808, communication robustness is verified throughout the testing. This can involve confirming that ESD protection remains inactive by maintaining trigger voltages above a set threshold, voltage comparators successfully detect differential signals despite common-mode noise attenuation, and reliable data transmission continues across the specified range of injection conditions. The method validates electromagnetic compatibility while maintaining low voltage ratings for most circuit components, preserving small device area and low manufacturing costs.

A first aspect relates to a battery management system, comprising a plurality of battery cells; a front-end circuit coupled to the battery cells; a BMS electronic control unit (ECU); and a communication interface circuit coupled between the front-end circuit and the BMS ECU, the communication interface circuit comprising a first half-bridge driver circuit and a second half-bridge driver circuit, a first internal isolation node coupled to the first half-bridge driver circuit, a second internal isolation node coupled to the second half-bridge driver circuit, a first external isolation node and a second external isolation node, a first resistive network coupled between the first internal isolation node and the first external isolation node, a second resistive network coupled between the second internal isolation node and the second external isolation node, a voltage comparator circuit coupled to the first external isolation node and the second external isolation node, a clamping circuit coupled to the first internal isolation node and the second internal isolation node, the clamping circuit configured to limit voltage excursions at the first internal isolation node and the second internal isolation node, and an electrostatic discharge (ESD) protection circuit coupled between the first external isolation node and the second external isolation node, the ESD protection circuit configured with trigger voltages exceeding a sum of a clamping voltage and voltage drops across the first resistive network and the second resistive network.

In a first implementation form of the battery management system, according to the first aspect as such, the first resistive network comprises three resistors coupled between the first internal isolation node and the first external isolation node, wherein a first resistor of the three resistors is a first pull-mode resistor, wherein a second resistor of the three resistors is a first series differential resistor, and wherein a third resistor of the three resistors is a first series board resistor.

In a second implementation form of the battery management system, according to the first aspect as such or any preceding implementation form of the first aspect, a resistance value of the first series differential resistor is maintained above zero.

In a third implementation form of the battery management system, according to the first aspect as such or any preceding implementation form of the first aspect, the communication interface circuit further comprises a second clamping circuit having a diode coupled between a supply voltage node of the half-bridge driver circuits and a ground node.

In a fourth implementation form of the battery management system, according to the first aspect as such or any preceding implementation form of the first aspect, the first half-bridge driver circuit comprises a diode coupled between a first transistor and the first internal isolation node.

In a fifth implementation form of the battery management system, according to the first aspect as such or any preceding implementation form of the first aspect, the clamping circuit comprises three diodes, wherein cathodes of the three diodes are coupled together at a common node, wherein an anode of a first diode is coupled to the first internal isolation node, wherein an anode of a second diode is coupled to the second internal isolation node, and wherein an anode of a third diode is coupled to ground.

In a sixth implementation form of the battery management system, according to the first aspect as such or any preceding implementation form of the first aspect, the voltage comparator circuit is configured to detect differential voltage patterns representing logic states between the first external isolation node and the second external isolation node.

A second aspect relates to a communication interface circuit, comprising a first half-bridge driver circuit and a second half-bridge driver circuit, a first internal isolation node coupled to the first half-bridge driver circuit, a second internal isolation node coupled to the second half-bridge driver circuit, a first external isolation node and a second external isolation node, a first resistive network coupled between the first internal isolation node and the first external isolation node, a second resistive network coupled between the second internal isolation node and the second external isolation node, a voltage comparator circuit coupled to the first external isolation node and the second external isolation node, a clamping circuit coupled to the first internal isolation node and the second internal isolation node, the clamping circuit configured to limit voltage excursions at the first internal isolation node and the second internal isolation node, and an electrostatic discharge (ESD) protection circuit coupled between the first external isolation node and the second external isolation node, the ESD protection circuit configured with trigger voltages exceeding a sum of a clamping voltage and voltage drops across the first resistive network and the second resistive network.

In a first implementation form of the communication interface circuit, according to the second aspect as such, the first resistive network comprises three resistors coupled between the first internal isolation node and the first external isolation node, wherein a first resistor of the three resistors is a first pull-mode resistor, wherein a second resistor of the three resistors is a first series differential resistor, and wherein a third resistor of the three resistors is a first series board resistor.

In a second implementation form of the communication interface circuit, according to the second aspect as such or any preceding implementation form of the second aspect, a resistance value of the first series differential resistor is maintained above zero.

In a third implementation form of the communication interface circuit, according to the second aspect as such or any preceding implementation form of the second aspect, the communication interface circuit further comprises a second clamping circuit having a diode coupled between a supply voltage node of the half-bridge driver circuits and a ground node.

In a fourth implementation form of the communication interface circuit, according to the second aspect as such or any preceding implementation form of the second aspect, the first half-bridge driver circuit comprises a diode coupled between a first transistor and the first internal isolation node.

In a fifth implementation form of the communication interface circuit, according to the second aspect as such or any preceding implementation form of the second aspect, the clamping circuit comprises three diodes, wherein cathodes of the three diodes are coupled together at a common node, wherein an anode of a first diode is coupled to the first internal isolation node, wherein an anode of a second diode is coupled to the second internal isolation node, and wherein an anode of a third diode is coupled to ground.

In a sixth implementation form of the communication interface circuit, according to the second aspect as such or any preceding implementation form of the second aspect, the voltage comparator circuit is configured to detect differential voltage patterns representing logic states between the first external isolation node and the second external isolation node.

A third aspect relates to a method of operating a communication interface circuit during electromagnetic compatibility testing, the method comprising implementing voltage clamping at a first internal isolation node and a second internal isolation node; generating differential signals using a first half-bridge driver circuit coupled to the first internal isolation node and a second half-bridge driver circuit coupled to the second internal isolation node; developing voltage drops across a first resistive network coupled between the first internal isolation node and a first external isolation node and a second resistive network coupled between the second internal isolation node and a second external isolation node; and detecting differential voltages between the first external isolation node and the second external isolation node using a voltage comparator circuit while maintaining electrostatic discharge protection trigger voltages above a sum of a clamping voltage and the voltage drops.

In a first implementation form of the method, according to the third aspect as such, implementing voltage clamping comprises utilizing body diodes of Metal-Oxide-Semiconductor Field-Effect Transistors in the first half-bridge driver circuit and the second half-bridge driver circuit, implementing a clamping diode at a supply voltage, implementing a dedicated clamping circuit with back-to-back diodes at the first internal isolation node and the second internal isolation node, or a combination thereof.

In a second implementation form of the method, according to the third aspect as such or any preceding implementation form of the third aspect, developing voltage drops comprises developing a first voltage drop across a first series differential resistor proportional to a sum of a common-mode current component and a differential current component; and developing a second voltage drop across a second series differential resistor proportional to a difference between the common-mode current component and the differential current component.

In a third implementation form of the method, according to the third aspect as such or any preceding implementation form of the third aspect, the method further comprising performing electromagnetic compatibility testing by injecting radio frequency power directly into the communication interface circuit during Direct Power Injection testing and inductively coupling radio frequency current into communication lines during Bulk Current Injection testing.

In a fourth implementation form of the method, according to the third aspect as such or any preceding implementation form of the third aspect, the method further comprising a common-mode voltage biasing circuit arranged between the first internal isolation node and the second internal isolation node; and common-mode resistors configured to maintain equal voltages at the first internal isolation node and the second internal isolation node in response to the communication being absent and allowing differential voltages to develop across the first resistive network and the second resistive network.

In a fifth implementation form of the method, according to the third aspect as such or any preceding implementation form of the third aspect, detecting differential voltages comprises detecting differential voltage patterns representing logic states for data recovery when differential signals are attenuated to one-third of normal differential voltage levels due to common-mode noise; and maintaining proper operation of the voltage comparator circuit across an expanded common-mode input range while preserving differential voltage detection sensitivity.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A battery management system, comprising:
a plurality of battery cells;
a front-end circuit coupled to the battery cells;
a BMS electronic control unit (ECU); and
a communication interface circuit coupled between the front-end circuit and the BMS ECU, the communication interface circuit comprising:
a first half-bridge driver circuit and a second half-bridge driver circuit,
a first internal isolation node coupled to the first half-bridge driver circuit,
a second internal isolation node coupled to the second half-bridge driver circuit,
a first external isolation node and a second external isolation node,
a first resistive network coupled between the first internal isolation node and the first external isolation node,
a second resistive network coupled between the second internal isolation node and the second external isolation node,
a voltage comparator circuit coupled to the first external isolation node and the second external isolation node,
a clamping circuit coupled to the first internal isolation node and the second internal isolation node, the clamping circuit configured to limit voltage excursions at the first internal isolation node and the second internal isolation node, and
an electrostatic discharge (ESD) protection circuit coupled between the first external isolation node and the second external isolation node, the ESD protection circuit configured with trigger voltages exceeding a sum of a clamping voltage and voltage drops across the first resistive network and the second resistive network.

2. The battery management system of claim 1, wherein the first resistive network comprises three resistors coupled between the first internal isolation node and the first external isolation node, wherein a first resistor of the three resistors is a first pull-mode resistor, wherein a second resistor of the three resistors is a first series differential resistor, and wherein a third resistor of the three resistors is a first series board resistor.

3. The battery management system of claim 2, wherein a resistance value of the first series differential resistor is maintained above zero.

4. The battery management system of claim 1, wherein the communication interface circuit further comprises a second clamping circuit having a diode coupled between a supply voltage node of the half-bridge driver circuits and a ground node.

5. The battery management system of claim 1, wherein the first half-bridge driver circuit comprises a diode coupled between a first transistor and the first internal isolation node.

6. The battery management system of claim 1, wherein the clamping circuit comprises three diodes, wherein cathodes of the three diodes are coupled together at a common node, wherein an anode of a first diode is coupled to the first internal isolation node, wherein an anode of a second diode is coupled to the second internal isolation node, and wherein an anode of a third diode is coupled to ground.

7. The battery management system of claim 1, wherein the voltage comparator circuit is configured to detect differential voltage patterns representing logic states between the first external isolation node and the second external isolation node.

8. A communication interface circuit, comprising:
a first half-bridge driver circuit and a second half-bridge driver circuit,
a first internal isolation node coupled to the first half-bridge driver circuit,
a second internal isolation node coupled to the second half-bridge driver circuit,
a first external isolation node and a second external isolation node,
a first resistive network coupled between the first internal isolation node and the first external isolation node,
a second resistive network coupled between the second internal isolation node and the second external isolation node,
a voltage comparator circuit coupled to the first external isolation node and the second external isolation node,
a clamping circuit coupled to the first internal isolation node and the second internal isolation node, the clamping circuit configured to limit voltage excursions at the first internal isolation node and the second internal isolation node, and
an electrostatic discharge (ESD) protection circuit coupled between the first external isolation node and the second external isolation node, the ESD protection circuit configured with trigger voltages exceeding a sum of a clamping voltage and voltage drops across the first resistive network and the second resistive network.

9. The communication interface circuit of claim 8, wherein the first resistive network comprises three resistors coupled between the first internal isolation node and the first external isolation node, wherein a first resistor of the three resistors is a first pull-mode resistor, wherein a second resistor of the three resistors is a first series differential resistor, and wherein a third resistor of the three resistors is a first series board resistor.

10. The communication interface circuit of claim 9, wherein a resistance value of the first series differential resistor is maintained above zero.

11. The communication interface circuit of claim 8, wherein the communication interface circuit further comprises a second clamping circuit having a diode coupled between a supply voltage node of the half-bridge driver circuits and a ground node.

12. The communication interface circuit of claim 8, wherein the first half-bridge driver circuit comprises a diode coupled between a first transistor and the first internal isolation node.

13. The communication interface circuit of claim 8, wherein the clamping circuit comprises three diodes, wherein cathodes of the three diodes are coupled together at a common node, wherein an anode of a first diode is coupled to the first internal isolation node, wherein an anode of a second diode is coupled to the second internal isolation node, and wherein an anode of a third diode is coupled to ground.

14. The communication interface circuit of claim 8, wherein the voltage comparator circuit is configured to detect differential voltage patterns representing logic states between the first external isolation node and the second external isolation node.

15. A method of operating a communication interface circuit during electromagnetic compatibility testing, the method comprising:
implementing voltage clamping at a first internal isolation node and a second internal isolation node;
generating differential signals using a first half-bridge driver circuit coupled to the first internal isolation node and a second half-bridge driver circuit coupled to the second internal isolation node;
developing voltage drops across a first resistive network coupled between the first internal isolation node and a first external isolation node and a second resistive network coupled between the second internal isolation node and a second external isolation node; and
detecting differential voltages between the first external isolation node and the second external isolation node using a voltage comparator circuit while maintaining electrostatic discharge protection trigger voltages above a sum of a clamping voltage and the voltage drops.

16. The method of claim 15, wherein implementing voltage clamping comprises utilizing body diodes of Metal-Oxide-Semiconductor Field-Effect Transistors in the first half-bridge driver circuit and the second half-bridge driver circuit, implementing a clamping diode at a supply voltage, implementing a dedicated clamping circuit with back-to-back diodes at the first internal isolation node and the second internal isolation node, or a combination thereof.

17. The method of claim 15, wherein developing voltage drops comprises:
developing a first voltage drop across a first series differential resistor proportional to a sum of a common-mode current component and a differential current component; and
developing a second voltage drop across a second series differential resistor proportional to a difference between the common-mode current component and the differential current component.

18. The method of claim 15, further comprising performing electromagnetic compatibility testing by injecting radio frequency power directly into the communication interface circuit during Direct Power Injection testing and inductively coupling radio frequency current into communication lines during Bulk Current Injection testing.

19. The method of claim 15, further comprising:
a common-mode voltage biasing circuit arranged between the first internal isolation node and the second internal isolation node; and
common-mode resistors configured to maintain equal voltages at the first internal isolation node and the second internal isolation node in response to the communication being absent and allowing differential voltages to develop across the first resistive network and the second resistive network.

20. The method of claim 15, wherein detecting differential voltages comprises:
detecting differential voltage patterns representing logic states for data recovery when differential signals are attenuated to one-third of normal differential voltage levels due to common-mode noise; and
maintaining proper operation of the voltage comparator circuit across an expanded common-mode input range while preserving differential voltage detection sensitivity.
